(19) United States
(12) Patent Application Publication
(10) Pub. No.: US 2025/0245954 A1
(43) Pub. Date: Jul. 31, 2025

(54) MULTI-DOMAIN OBJECT DETECTION METHOD AND APPARATUS

(71) Applicants: HYUNDAI MOTOR COMPANY, SEOUL (KR); KIA CORPORATION, SEOUL (KR); AJOU UNIVERSITY INDUSTRY-ACADEMIC COOPERATION FOUNDATION, SUWON-SI (KR)

(72) Inventors: Jiwon Kim, Hwaseong-si (KR); Keonho Lee, Hwaseong-si (KR); Kyunghwan Cho, Hwaseong-si (KR); Moonsub Jin, Hwaseong-si (KR); Wonjun Hwang, Seoul (KR); Taehoon Kim, Suwon-si (KR); Seungsoo Yu, Suwon-si (KR); Dinh Phat Do, Suwon-si (KR)

(73) Assignees: HYUNDAI MOTOR COMPANY, SEOUL (KR); KIA CORPORATION, SEOUL (KR); AJOU UNIVERSITY INDUSTRY-ACADEMIC COOPERATION FOUNDATION, SUWON-SI (KR)

(21) Appl. No.: 19/035,188

(22) Filed: Jan. 23, 2025

(30) Foreign Application Priority Data
Jan. 30, 2024 (KR) 10-2024-0013805
Jan. 22, 2025 (KR) 10-2025-0009180

(51) Int. Cl. G06V 10/25; G01S 17/89; G06V 10/771; G06V 20/70

(52) U.S. Cl. CPC G06V 10/25; G01S 17/89; G06V 10/771; G06V 20/70; G06V 2201/07

(57) ABSTRACT

A multi-domain object detection method includes generating a teacher model and a student model from a pre-trained model, inputting an image with weak augmentation applied to a target image, for which an object is to be detected, to the teacher model, determining whether a pseudo label generated by the teacher model is below a preset threshold, performing negative learning for a class corresponding to the pseudo label when the pseudo label is determined to be below the threshold, inputting an image with strong augmentation applied to the target image to the student model, calculating an unsupervised loss by comparing a first prediction generated by the student model with the pseudo label, updating the teacher model using an exponential moving average (EMA) predetermined in the student model, and detecting an object in an image from another domain using the teacher model.

### CROSS REFERENCE TO RELATED APPLICATIONS

This application claims priority to and the benefit of Korean Patent Application No. 10-2024-0013805 filed in the Korean Intellectual Property Office on Jan. 30, 2024, and Korean Patent Application No. 10-2025-0009180 filed in the Korean Intellectual Property Office on Jan. 22, 2025 and the entire contents of which are incorporated herein by reference.

### BACKGROUND

### (a) Field

The disclosure relates to a multi-domain object detection method and apparatus through category-based domain learning.

### (b) Description of the Related Art

Deep learning models require a large amount of labeled image data to accurately detect or classify objects. However, the process of collecting and generating labeled images is both time-consuming and costly. In particular, acquiring data from various domains poses a challenge. Domain adaptation is a technology proposed to address this issue, aiming to reduce the gap between a labeled source domain and an unlabeled target domain. Generally, domain adaptation operates by training the model based on calculating the differences between the source and target domains using the entire feature map of the images from both domains.

However, in the field of object detection, conventional domain adaptation methods may not always achieve sufficient learning effectiveness. This is because each object category possesses unique features, and the differences between domains can be significant. For example, even for the same object, its representation can vary greatly depending on the domain, such as RGB, infrared (IR), or thermal imaging. Consequently, the model may struggle to effectively learn these variations. Due to these challenges, conventional domain adaptation methodologies alone may not be sufficient to ensure satisfactory performance in object detection tasks.

### SUMMARY

A problem to be solved is to provide a multi-domain object detection method and apparatus that can effectively learn the intrinsic features of objects regardless of the domain and enhance object detection performance for data from new domains.

An example embodiment of the present disclosure may provide a multi-domain object detection method through category-based domain learning, performed by a computing device including a processor and a memory, the method including generating, by the processor, a teacher model and a student model from a pre-trained model, inputting, by the processor, an image with weak augmentation applied to a target image, for which an object is to be detected, to the teacher model, determining, by the processor, whether a pseudo label generated by the teacher model is below a preset threshold, performing, by the processor, negative learning for a class corresponding to the pseudo label when the pseudo label is determined to be below the threshold, inputting, by the processor, an image with strong augmentation applied to the target image to the student model, calculating, by the processor, an unsupervised loss by comparing a first prediction generated by the student model with the pseudo label, updating, by the processor, the teacher model using an exponential moving average (EMA) predetermined in the student model, and detecting, by the processor, an object in an image from another domain using the teacher model.

In some example embodiments, the method may further include passing, by the processor, a feature map generated by the student model to a first discriminator, and transmitting, by the processor, the feature map to a first head that generates the first prediction.

In some example embodiments, the determining whether the pseudo label generated by the teacher model is below a preset threshold may include, determining, by the processor, whether a first pseudo label having the highest class probability value among the pseudo labels is below the threshold, and, the performing the negative learning may include: selecting, by the processor, k pseudo labels (where k is a natural number) from the pseudo labels, excluding the first pseudo label, when the first pseudo label is determined to be below the threshold; and performing, by the processor, the negative learning for the classes corresponding to the first pseudo label and the k pseudo labels.

In some example embodiments, the performing the negative learning may include, performing, by the processor, the negative learning based on a negative learning loss according to the following mathematical expression:

$$- \frac{1}{B} {\sum }_{i = 1}^{B} {\sum }_{c = 1}^{C} [ Rank ( {q}_{c}^{( i )} ) > k ] log ( 1 - {p}_{c}^{( i )} )$$

wherein B is a batch size, C is an object category class, [symbol] is an indicator function, p⁽ⁱ⁾_{c} is a probability that a sample does not belong to class c, q⁽ⁱ⁾_{c} is a probability predicted by the model for class c of i-th sample, Rank is ranking sorted in descending order based on confidence scores, and k is the top k ranks calculated adaptively.

In some example embodiments, the first prediction may include a class prediction value and a bounding box prediction value.

In some example embodiments, the method may further include performing, by the processor, pre-training based on a pre-configured second discriminator.

In some example embodiments, the performing the pre-training may include: inputting, by the processor, a pre-configured dataset to a backbone to generate a feature map; passing, by the processor, the feature map to the second discriminator and transmitting the feature map to a second head that generates a second prediction; and calculating, by the processor, a supervised loss by comparing the second prediction with ground truth, and updating weights through backpropagation.

In some example embodiments, the performing the pre-training may include, repeating the pre-training for a predetermined number of iterations.

In some example embodiments, the second prediction may include a class prediction value and a bounding box prediction value.

In some example embodiments, the detecting the object in an image from another domain using the teacher model may include, detecting the object in an IR (Infrared) domain related to IR images, a thermal imaging domain related to thermal images, or a LiDAR (Light Detection And Ranging) domain related to LiDAR images using the teacher model trained in an RGB domain related to RGB images.

An example embodiment of the present disclosure may provide a multi-domain object detection apparatus for performing object detection through category-based domain learning, by executing at least one instruction loaded into at least one memory device via at least one processor, the at least one instruction, when executed, causing the at least one processor to generate a teacher model and a student model from a pre-trained model, input an image with weak augmentation applied to a target image, for which an object is to be detected, to the teacher model, determine whether a pseudo label generated by the teacher model is below a preset threshold, perform negative learning for a class corresponding to the pseudo label when the pseudo label is determined to be below the threshold, input an image with strong augmentation applied to the target image to the student model, calculate an unsupervised loss by comparing a first prediction generated by the student model with the pseudo labe,; update the teacher model using an exponential moving average (EMA) predetermined in the student model, and detect an object in an image from another domain using the teacher model.

In some example embodiments, the at least one instruction, when executed, may further cause the at least one processor to pass a feature map generated by the student model to a first discriminator, and transmit the feature map to a first head that generates the first prediction.

In some example embodiments, the determining whether the pseudo label generated by the teacher model is below a preset threshold may include, determining whether a first pseudo label having the highest class probability value among the pseudo labels is below the threshold, and the performing the negative learning may include selecting k pseudo labels (where k is a natural number) from the pseudo labels, excluding the first pseudo label, when the first pseudo label is determined to be below the threshold, and performing the negative learning for the classes corresponding to the first pseudo label and the k pseudo labels.

In some example embodiments, the performing the negative learning may include, performing the negative learning based on a negative learning loss according to the following mathematical expression:

$$- \frac{1}{B} {\sum }_{i = 1}^{B} {\sum }_{c = 1}^{C} [ Rank ( {q}_{c}^{( i )} ) > k ] log ( 1 - {p}_{c}^{( i )} )$$

wherein B is a batch size, C is an object category class, [symbol] is an indicator function, p⁽ⁱ⁾_{c} is a probability that a sample does not belong to class c, q⁽ⁱ⁾_{c} is a probability predicted by the model for class c of i-th sample, Rank is ranking sorted in descending order based on confidence scores, and k is the top k ranks calculated adaptively.

In some example embodiments, the first prediction may include a class prediction value and a bounding box prediction value.

In some example embodiments, the at least one instruction, when executed, may further cause the at least one processor to perform pre-training based on a pre-configured second discriminator.

In some example embodiments, wherein the performing the pre-training may include inputting a pre-configured dataset to a backbone to generate a feature map, passing the feature map to the second discriminator and transmitting the feature map to a second head that generates a second prediction, and calculating a supervised loss by comparing the second prediction with ground truth, and updating weights through backpropagation.

In some example embodiments, the performing the pre-training may include, repeating the pre-training for a predetermined number of iterations.

In some example embodiments, the second prediction may include a class prediction value and a bounding box prediction value.

In some example embodiments, the detecting the object in an image from another domain using the teacher model may include, detecting the object in an IR (Infrared) domain related to IR images, a thermal imaging domain related to thermal images, or a LiDAR (Light Detection And Ranging) domain related to LiDAR images using the teacher model trained in an RGB domain related to RGB images.

### BRIEF DESCRIPTION OF THE FIGURES

FIG. 1 is a block diagram illustrating a multi-domain object detection apparatus according to one or more embodiments.

FIG. 2 is a diagram illustrating an example implementation of a multi-domain object detection apparatus according to one or more embodiments.

FIGS. 3 to 4 are flowcharts illustrating a multi-domain object detection method according to one or more embodiments.

FIG. 5 is a flowchart illustrating a multi-domain object detection method according to one or more embodiments.

FIG. 6 is a diagram illustrating a computing device according to one or more embodiments.

### DETAILED DESCRIPTION

The present disclosure will be described more fully hereinafter with reference to the accompanying drawings, in which example embodiments of the disclosure are shown. As those skilled in the art would realize, the described example embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various components, but the components are not limited by the terms. The terms are used only to discriminate one component from another component.

Terms such as “part,” “unit,” “module,” and the like in the specification may refer to a unit capable of performing at least one function or operation described herein, which may be implemented in hardware or circuitry, software, or a combination of hardware or circuitry and software. In addition, at least some of the configurations or functions of multi-domain object detection method and apparatus through category-based domain learning according to the example embodiments described below may be implemented as programs or software, and the programs or software may be stored on a computer-readable medium.

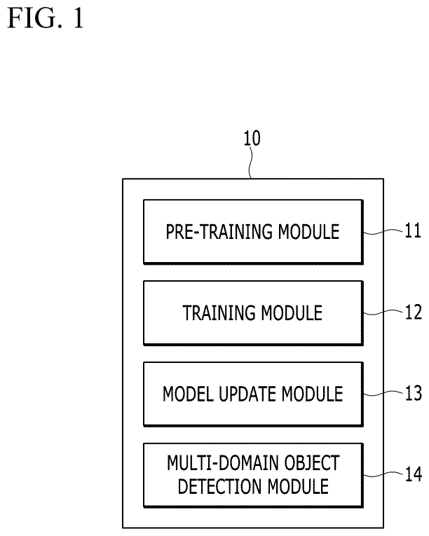

FIG. 1 is a block diagram illustrating a multi-domain object detection apparatus according to one or more embodiments.

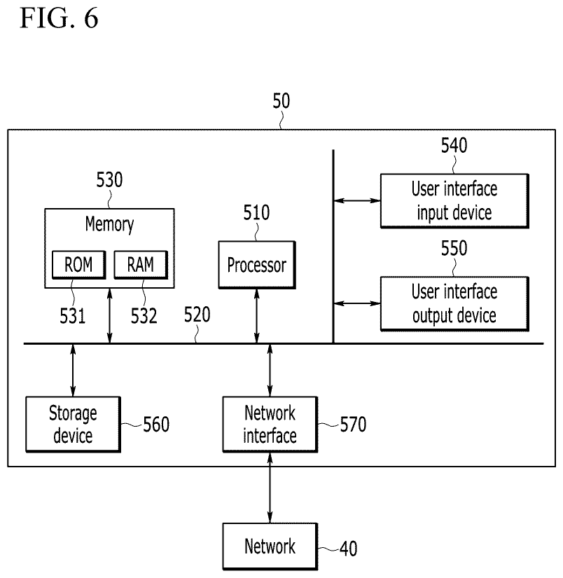

Referring to FIG. 1, a multi-domain object detection apparatus 10 according to one or more embodiments may execute program code or instructions loaded into at least one memory device via at least one processor. For example, the multi-domain object detection apparatus 10 may be implemented as a computing device 50, as described later with reference to FIG. 6. In this case, the at least one processor may correspond to processor 510 of computing device 50, and the at least one memory device may correspond to memory 530 of computing device 50. The program code or instructions, when executed by the at least one processor, may perform object detection through category-based domain learning. In this specification, the term “module” is used to logically distinguish the functions performed by the program code.

The multi-domain object detection apparatus 10 may include a pre-training module 11, a training module 12, a model update module 13, and a multi-domain object detection module 14.

The pre-training module 11 may perform pre-training based on a pre-configured discriminator. The discriminator used for pre-training may also be referred to as a source discriminator. In contrast, the discriminator used in the training, which will be described below, may be referred to as a target discriminator to distinguish it from the source discriminator.

In some embodiments, the source discriminator and the target discriminator may use the same structure. Specifically, both the source discriminator and the target discriminator may learn the intrinsic features of the same classes (e.g., cars, people, bicycles, etc.), and they may have physically identical network architectures while using different weights. In such an implementation, the weights of the source discriminator learned during the pre-training process may be used as initial values in the training process, thereby improving learning efficiency. However, the scope of the present disclosure is not limited to the source discriminator and the target discriminator having the same structure.

The pre-training module 11 may generate a feature map by inputting a pre-configured dataset to a backbone. The backbone functions to hierarchically extract features from low-level to high-level by processing the input data and may be implemented, for example, as a Convolutional Neural Network (CNN) structure. The backbone extracts key features such as the shape, boundary, and texture of objects to generate the feature map. The feature map preserves the essential information of the input data and provides foundational data for subsequent stages of object detection and classification.

The pre-training module 11 may pass the feature map to the source discriminator and then transmit it to a head that generates a prediction. The prediction may include a class prediction value and a bounding box prediction value. The head is responsible for calculating the class and location information of objects included in the input data based on the feature map. For example, the head may be configured with a Fully Connected Layer or a Convolutional Layer. The class prediction value represents the probability that the input data belongs to a specific class, while the bounding box prediction value may include coordinate information representing the position and size of the object. The prediction may be combined with the output of the source discriminator to enhance the accuracy of object detection and classification.

Specifically, the pre-training module 11 may transmit the feature map to the head after first passing it through the source discriminator, rather than directly delivering it to the head. This allows the extracted features from the backbone to be distinguished based on their originating domain, enabling more effective learning of the unique characteristics of each object class. During the initial training stage, the source discriminator differentiates the domain of the feature map, thereby reinforcing the learning of class-specific intrinsic features. However, as training progresses, the discriminator gradually loses its ability to distinguish between domains. This guides the model to learn only the intrinsic features of objects, regardless of whether they belong to the source or target domain. As a result, the model can generalize the intrinsic features of each class without being affected by domain differences. Consequently, the model trained on the source domain can achieve high performance even in the target domain.

The pre-training module 11 may calculate a supervised loss by comparing the prediction with ground truth and update the weights through backpropagation. The supervised loss numerically represents the model's error by calculating the difference between the prediction (e.g., class and bounding box) and the ground truth. Backpropagation is an algorithm that updates the network's weights based on the calculated loss. For example, it may utilize gradient descent to adjust the weights and biases of each layer.

The pre-training module 11 may repeatedly perform the pre-training described above for a predetermined number of iterations.

The training module 12 may generate a teacher model and a student model from the pre-trained model provided by the pre-training module 11. The teacher model is maintained in a state where its weights are fixed (frozen) and are not updated during training, primarily serving the role of generating pseudo labels for the target data. The teacher model may take an image with weak augmentation applied as input and generate initial prediction results, such as class prediction values and bounding box prediction values. These prediction results can be used as reference data for training the student model.

The student model initially has the same weights as the teacher model, however, its weights may be updated through backpropagation during the training process. The student model takes an image with strong augmentation applied as input, calculates a loss by comparing it with the pseudo labels generated by the teacher model, and gradually improves domain adaptation and object detection performance based on this loss. Additionally, during the training process, the weights of the student model are periodically used to update the weights of the teacher model using an Exponential Moving Average (EMA). This allows the teacher model to maintain a more generalized state as the training progresses.

The training module 12 may input an image with weak augmentation applied to a target image, for which an object is to be detected, to the teacher model. Weak augmentation refers to performing minor transformations such as brightness adjustment, contrast adjustment, and Gaussian blur while preserving the main features of the input data.

The training module 12 may determine whether a pseudo label generated by the teacher model is below a preset threshold, and if the pseudo label is determined to be below the threshold, it may perform negative learning for the class corresponding to the pseudo label. Negative learning is a process that enables the model to learn that specific data does not belong to a particular class. In other words, when the confidence of the pseudo label generated by the teacher model is low, the model learns information that the data does not belong to the corresponding class, thereby contributing to reducing prediction errors.

The training module 12 may determine whether a first pseudo label, which has the highest class probability value among the pseudo labels, is below a preset threshold in order to determine whether the pseudo label generated by the teacher model is below the threshold. If the first pseudo label is determined to be below the threshold, the training module 12 may select k pseudo labels (where k is a natural number) from the remaining pseudo labels excluding the first pseudo label, and perform negative learning for the classes corresponding to the first pseudo label and the k pseudo labels.

Specifically, the first pseudo label, which has the highest class probability value among the pseudo labels generated by the teacher model, may indicate the likelihood that the given data belongs to a specific class. However, if the probability value of the first pseudo label is below the preset threshold, the prediction result of the teacher model may be considered unreliable. For example, if the model predicts the probability of the “bicycle” class as 0.4 for a particular data sample, but the threshold is set to 0.5, the prediction may be regarded as having low confidence. By selecting the top k pseudo labels, excluding the first pseudo label (the class with the highest probability value), among the remaining classes that the model considers most probable, the target classes for negative learning can be diversified. This allows the model to better learn the differences between multiple classes.

In some embodiments, the training module 12 may perform negative learning based on a negative learning loss according to the following mathematical expression.

$$- \frac{1}{B} {\sum }_{i = 1}^{B} {\sum }_{c = 1}^{C} [ Rank ( {q}_{c}^{( i )} ) > k ] log ( 1 - {p}_{c}^{( i )} )$$

Here, B is a batch size, which represents the number of data samples processed during a single training iteration; C is an object category class; [symbol] is an indicator function that returns 1 if a given condition is satisfied and 0 otherwise; p⁽ⁱ⁾_{c} is a probability that a sample does not belong to class c; q⁽ⁱ⁾_{c} is a probability predicted by the model for class c of the i-th sample; Rank is ranking sorted in descending order based on confidence scores (in the mathematical expression, it represents the rank of the predicted probability q⁽ⁱ⁾_{c} for class c, where a higher probability corresponds to a lower rank); and k is the top k ranks, which are adaptively calculated based on the model's performance and dynamically determined.

The training module 12 may input an image with strong augmentation applied to the target image to the student model.

The training module 12 may calculate an unsupervised loss by comparing the prediction generated by the student model with the pseudo label. The prediction may include a class prediction value and a bounding box prediction value. Strong augmentation increases the intensity of transformations applied to the input image and may involve various techniques that alter or distort parts of the image. Examples of such techniques include rotation, scaling, cropping, color jitter, contrast adjustment, and the addition of Gaussian noise.

The training module 12 may pass the feature map generated by the student model to a discriminator, specifically a target discriminator, before transmitting it to a head that generates the prediction. In other words, the training module 12 may first pass the feature map through the target discriminator instead of directly delivering it to the head. This process allows the student model to improve object detection performance in the target domain. The target discriminator is trained to determine whether the feature map originates from the source domain or the target domain. Through this process, the student model can better understand domain differences and learn the intrinsic features of objects regardless of the domain. Additionally, the feature map that passes through the target discriminator is adjusted to better reflect the intrinsic characteristics of the object category, contributing to improving the accuracy of the class prediction value and the bounding box prediction value. As training progresses, the target discriminator gradually loses its ability to distinguish between domains, which guides the student model to learn the intrinsic characteristics of each class without boundaries between the source and target domains. This enhances domain adaptation performance. With this design, the training module 12 can provide consistent object detection performance across various domains.

The model update module 13 may update the teacher model using a predetermined Exponential Moving Average (EMA) from the student model.

Through this process, the interaction between the teacher model and the student model can result in the creation of a robust model capable of effectively detecting objects in the target domain.

The multi-domain object detection module 14 may detect objects in images from different domains using the teacher model. For example, the multi-domain object detection module 14 may detect objects in IR (Infrared) images related to the IR domain, thermal images related to the thermal imaging domain, or LiDAR (Light Detection And Ranging) images related to the LiDAR domain by utilizing the teacher model trained in the RGB domain for RGB images. According to this embodiment, even in situations where the target domain data lacks labels, robust object detection performance can be achieved in the target domain by utilizing only the source domain data. In particular, by leveraging a category discriminator to learn the intrinsic features of objects, the domain gap can be effectively overcome, significantly improving object detection performance in the target domain. Furthermore, by utilizing the enhanced target domain object detector together with the source domain object detector, more robust and reliable object detection can be achieved across various domain environments.

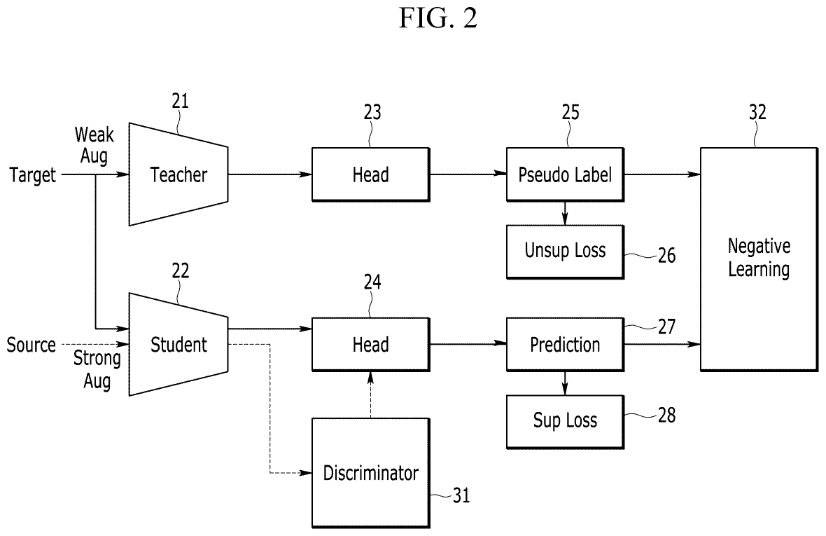

FIG. 2 is a diagram illustrating an example implementation of a multi-domain object detection apparatus according to one or more embodiments.

Referring to FIG. 2, a multi-domain object detection apparatus according to one or more embodiments may generate a teacher model 21 and a student model 22 from a pre-trained model. The apparatus may input an image with weak augmentation applied to a target image into the teacher model 21, determine whether a pseudo label 25 generated by the teacher model is below a preset threshold, and, if the pseudo label 25 is determined to be below the threshold, perform negative learning 32 for the class corresponding to the pseudo label 25. Meanwhile, the multi-domain object detection apparatus may input an image with strong augmentation applied to the target image into the student model 22 and calculate an unsupervised loss 26 by comparing a prediction 27 generated by the student model 22 with the pseudo label 25. Subsequently, the multi-domain object detection apparatus may update the teacher model 21 using a predetermined exponential moving average from the student model 22. In particular, the multi-domain object detection apparatus may pass the feature map generated by the student model 22 through a discriminator 31 and then transmit it to a head 24 to generate the prediction 27.

Meanwhile, in the illustrated diagram, the supervised loss 28 may be generated during the pre-training phase by comparing the prediction 27—produced after the feature map, generated by inputting a pre-configured dataset into the backbone, passes through the discriminator 31 and is transmitted to the head 24—with the ground truth.

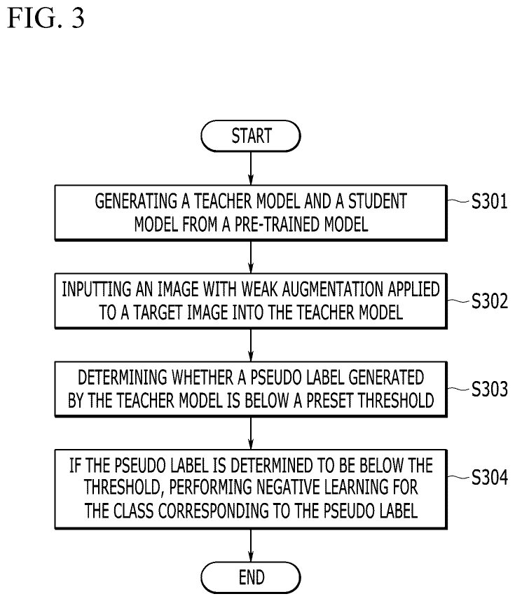

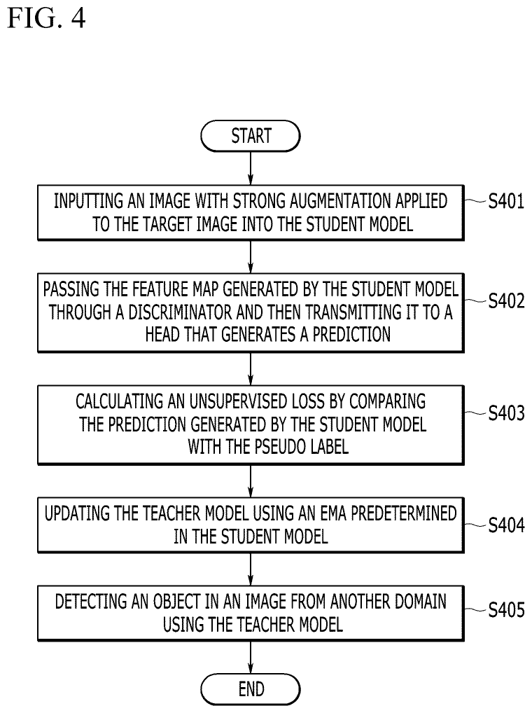

FIGS. 3 to 4 are flowcharts illustrating a multi-domain object detection method according to one or more embodiments.

Referring to FIG. 3, a multi-domain object detection method according to one or more embodiments may include: generating a teacher model and a student model from a pre-trained model (S301), inputting an image with weak augmentation applied to a target image into the teacher model (S302), determining whether a pseudo label generated by the teacher model is below a preset threshold (S303), and if the pseudo label is determined to be below the threshold, performing negative learning for the class corresponding to the pseudo label (S304).

Referring to FIG. 4, the multi-domain object detection method may further include: inputting an image with strong augmentation applied to the target image into the student model (S401), passing the feature map generated by the student model through a discriminator and then transmitting it to a head that generates a prediction (S402), calculating an unsupervised loss by comparing the prediction generated by the student model with the pseudo label (S403), updating the teacher model using an exponential moving average (EMA) predetermined in the student model (S404), and detecting an object in an image from another domain using the teacher model (S405).

S301 to S304 and S401 to S404 correspond to the training and model update process, while step S405 corresponds to the process of performing object detection on data from a new domain.

Further details regarding the above method can be found in the descriptions of other embodiments provided in this specification; therefore, redundant content is omitted here.

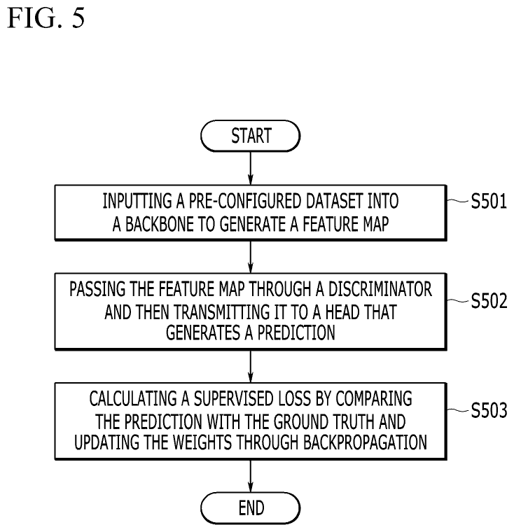

FIG. 5 is a flowchart illustrating a multi-domain object detection method according to one or more embodiments.

Referring to FIG. 5, a multi-domain object detection method according to one or more embodiments may include inputting a pre-configured dataset into a backbone to generate a feature map (S501), passing the feature map through a discriminator and then transmitting it to a head that generates a prediction (S502), and calculating a supervised loss by comparing the prediction with the ground truth and updating the weights through backpropagation (S503). S501 to S503 may correspond to the pre-training process.

Further details regarding the above method can be found in the descriptions of other embodiments provided in this specification; therefore, redundant content is omitted here.

FIG. 6 is a diagram illustrating a computing device according to one or more embodiments.

Referring to FIG. 6, a multi-domain object detection method and apparatus according to one or more embodiments may be implemented using computing device 50. Computing device 50 may be implemented in various forms, such as an electronic device, a server, or similar devices, and its functionality may be implemented through a combination of software and hardware.

Computing device 50 may include at least one of a processor 510, a memory 530, a user interface input device 540, a user interface output device 550, and a storage device 560, which communicate via a bus 520. Computing device 50 may also include a network interface 570 that is electrically connected to a network 40. Network interface 570 may transmit or receive signals to and from other entities via network 40.

Processor 510 may be implemented as various types of computing units, such as a Microcontroller Unit (MCU), an Application Processor (AP), a Central Processing Unit (CPU), a Graphics Processing Unit (GPU), a Neural Processing Unit (NPU), or a Quantum Processing Unit (QPU). Processor 510, which is a semiconductor device that executes instructions stored in memory 530 or storage device 560, may perform a core role in the system. The program code and data stored in memory 530 or storage device 560 instruct processor 510 to perform specific tasks, thereby enabling the overall operation of the system. Through this, processor 510 may be configured to implement the various functions and methods described above in relation to FIGS. 1 to 5.

Memory 530 and storage device 560 may include various types of volatile or non-volatile storage medium for storing and accessing system data. For example, memory 530 may include read-only memory (ROM) 531 and random access memory (RAM) 532. In some embodiments, memory 530 may be embedded within processor 510, allowing for high data transfer speeds between memory 530 and processor 510. In other embodiments, memory 530 may be located externally to processor 510, in which case it may be connected to processor 510 through various data buses or interfaces. Such connections may be established using various known means, such as a Peripheral Component Interconnect Express (PCIe) interface or a memory controller, to facilitate high-speed data transmission.

In some embodiments, at least a part of the configurations or functions of a multi-domain object detection method and apparatus according to one or more embodiments may be implemented as a program or software executed by computing device 50, and the program or software may be stored in a computer-readable recording medium or storage medium. Specifically, a computer-readable recording medium or storage medium according to one or more embodiments may store a program that executes the steps included in the implementation of the multi-domain object detection method and apparatus. The program may be recorded in a computer that includes processor 510 executing the program or commands stored in memory 530 or storage device 560.

In some embodiments, at least a part of the configurations or functions of a multi-domain object detection method and apparatus according to one or more embodiments may be implemented using the hardware or circuitry of computing device 50, or may be implemented as separate hardware or circuitry that can be electrically connected to computing device 50.

According to example embodiments, even in situations where the target domain data lacks labels, robust object detection performance can be achieved in the target domain by utilizing only the source domain data. In particular, by leveraging a category classifier to learn the intrinsic features of objects, the domain gap can be effectively overcome, significantly improving object detection performance in the target domain. Furthermore, by utilizing the enhanced target domain object detector together with the source domain object detector, more robust and reliable object detection can be achieved across various domain environments.

Although the above example embodiments of the present disclosure have been described in detail, the scope of the present disclosure is not limited thereto, but also includes various modifications and improvements by one of ordinary skill in the art utilizing the basic concepts of the present disclosure as defined in the following claims.

1. A multi-domain object detection method through category-based domain learning, performed by a computing device including a processor and a memory, the method comprising:
generating, by the processor, a teacher model and a student model from a pre-trained model;
inputting, by the processor, an image with weak augmentation applied to a target image, for which an object is to be detected, to the teacher model;
determining, by the processor, whether a pseudo label generated by the teacher model is below a preset threshold;
when the pseudo label is determined to be below the preset threshold, performing, by the processor, negative learning for a class corresponding to the pseudo label;
inputting, by the processor, an image with strong augmentation applied to the target image to the student model;
calculating, by the processor, an unsupervised loss by comparing a first prediction generated by the student model with the pseudo label;
updating, by the processor, the teacher model using an exponential moving average (EMA) predetermined in the student model; and
detecting, by the processor, an object in an image from another domain using the teacher model.

2. The method of claim 1, further comprising:
passing, by the processor, a feature map generated by the student model to a first discriminator, and transmitting, by the processor, the feature map to a first head that generates the first prediction.

3. The method of claim 1, wherein the determining whether the pseudo label generated by the teacher model is below a preset threshold comprises:
the pseudo label comprises a plurality of pseudo labels;
determining, by the processor, whether a first pseudo label having a highest class probability value among the plurality of pseudo labels is below the preset threshold; and,
the performing the negative learning comprises:
selecting, by the processor, k pseudo labels, where k is a natural number, from the plurality of pseudo labels, excluding the first pseudo label, when the first pseudo label is determined to be below the preset threshold; and
performing, by the processor, the negative learning for classes corresponding to the first pseudo label and the k pseudo labels.

4. The method of claim 1, wherein the performing the negative learning comprises:
performing, by the processor, the negative learning based on a negative learning loss according to:
$$- \frac{1}{B} {\sum }_{i = 1}^{B} {\sum }_{c = 1}^{C} [ Rank ( {q}_{c}^{( i )} ) > k ] log ( 1 - {p}_{c}^{( i )} )$$
wherein B is a batch size, C is an object category class, [symbol] is an indicator function, p⁽ⁱ⁾_{c} is a probability that a sample does not belong to class c, q⁽ⁱ⁾_{c} is a probability predicted by a model for class c of i-th sample, Rank is ranking sorted in descending order based on confidence scores, and k is the top k ranks calculated adaptively.

5. The method of claim 1, wherein the first prediction comprises a class prediction value and a bounding box prediction value.

6. The method of claim 1, further comprising:
performing, by the processor, pre-training based on a pre-configured second discriminator.

7. The method of claim 6, wherein the performing the pre-training comprises:
inputting, by the processor, a pre-configured dataset to a backbone to generate a feature map;
passing, by the processor, the feature map to the pre-configured second discriminator and transmitting the feature map to a second head that generates a second prediction; and
calculating, by the processor, a supervised loss by comparing the second prediction with ground truth, and updating weights through backpropagation.

8. The method of claim 6, wherein the performing the pre-training comprises repeating the pre-training for a predetermined number of iterations.

9. The method of claim 7, wherein the second prediction comprises a class prediction value and a bounding box prediction value.

10. The method of claim 1, wherein the detecting the object in an image from another domain using the teacher model comprises:
detecting the object in an infrared (IR) domain related to IR images, a thermal imaging domain related to thermal images, or a Light Detection And Ranging (LiDAR) domain related to LiDAR images using the teacher model trained in an RGB domain related to RGB images.

11. A multi-domain object detection apparatus for performing object detection through category-based domain learning, the apparatus comprising a memory storing computer-executable instructions, and at least one processor configured to access the memory and execute the instructions, wherein the instructions comprise:
generating a teacher model and a student model from a pre-trained model;
inputting an image with weak augmentation applied to a target image, for which an object is to be detected, to the teacher model;
determining whether a pseudo label generated by the teacher model is below a preset threshold;
when the pseudo label is determined to be below the preset threshold, performing negative learning for a class corresponding to the pseudo label;
inputting an image with strong augmentation applied to the target image to the student model;
calculating an unsupervised loss by comparing a first prediction generated by the student model with the pseudo label;
updating the teacher model using an exponential moving average (EMA) predetermined in the student model; and
detecting an object in an image from another domain using the teacher model.

12. The apparatus of claim 11, wherein the instructions further comprise passing a feature map generated by the student model to a first discriminator, and transmitting the feature map to a first head that generates the first prediction.

13. The apparatus of claim 11, wherein:
the determining whether the pseudo label generated by the teacher model is below a preset threshold comprises:
the pseudo label comprises a plurality of pseudo labels;
determining whether a first pseudo label having the highest class probability value among the plurality of pseudo labels is below the preset threshold, and
the performing the negative learning comprises:
selecting k pseudo labels, where k is a natural number, from the plurality of pseudo labels, excluding the first pseudo label, when the first pseudo label is determined to be below the preset threshold; and
performing the negative learning for classes corresponding to the first pseudo label and the k pseudo labels.

14. The apparatus of claim 11, wherein the performing the negative learning comprises:
performing the negative learning based on a negative learning loss according to:
$$- \frac{1}{B} {\sum }_{i = 1}^{B} {\sum }_{c = 1}^{C} [ Rank ( {q}_{c}^{( i )} ) > k ] log ( 1 - {p}_{c}^{( i )} )$$
wherein B is a batch size, C is an object category class, [symbol] is an indicator function, p⁽ⁱ⁾_{c} is a probability that a sample does not belong to class c, q⁽ⁱ⁾_{c} is a probability predicted by a model for class c of i-th sample, Rank is ranking sorted in descending order based on confidence scores, and k is the top k ranks calculated adaptively.

15. The apparatus of claim 11, wherein the first prediction comprises a class prediction value and a bounding box prediction value.

16. The apparatus of claim 11, wherein the instructions further comprise performing pre-training based on a pre-configured second discriminator.

17. The apparatus of claim 16, wherein the performing the pre-training comprises:
inputting a pre-configured dataset to a backbone to generate a feature map;
passing the feature map to the pre-configured second discriminator and transmitting the feature map to a second head that generates a second prediction; and
calculating a supervised loss by comparing the second prediction with ground truth, and updating weights through backpropagation.

18. The apparatus of claim 16, wherein the performing the pre-training comprises repeating the pre-training for a predetermined number of iterations.

19. The apparatus of claim 17, wherein the second prediction comprises a class prediction value and a bounding box prediction value.

20. The apparatus of claim 11, wherein the detecting the object in an image from another domain using the teacher model comprises:
detecting the object in an infrared (IR) domain related to IR images, a thermal imaging domain related to thermal images, or a Light Detection And Ranging (LiDAR) domain related to LiDAR images using the teacher model trained in an RGB domain related to RGB images.
